(19) United States
(12) Patent Application Publication
(10) Pub. No.: US 2002/0194066 A1
(43) Pub. Date: Dec. 19, 2002

(54) Method and apparatus for content promotion via a network

(76) Inventor: Larry Shultz, Beverly Hills, CA (US)

Correspondence Address: Anthony T. Cascio, BURNS, DOANE, SWECKER & MATHIS, L.L.P., P.O. Box 1404, Alexandria, VA, 22313-1404, US

(21) Appl. No.: 09/882,306

(22) Filed: Jun. 13, 2001

(51) Int. Cl. G06F 17/60

(52) U.S. Cl. 705/14

(57) ABSTRACT

Exemplary embodiments are directed to providing in a computing environment including a network, a web page accessible via said network, and a contest server including a storage medium having an object file, a method for content promotion including accessing from a user client the web page stored in association with the contest server via the network, wherein the web page includes an indicia corresponding with the object file, obtaining a contestant identification, wherein the contestant identification corresponds to the user client, selecting the indicia to provide an opportunity to purchase a content of the content promotion, engaging the object file corresponding to the indicia, and sending to the contest server the contestant identification with an acknowledgment of the selected indicia to enter the user client into a contest.

### RELATED APPLICATIONS

The present application relates to a co-pending U.S. patent application Ser. No. 09/551,736, filed on Apr. 18, 2000, entitled: METHOD OF CONDUCTING A CONTEST OVER A PUBLIC COMPUTER NETWORK (Attorney Docket No. 033144-002) by Larry Shultz, the disclosure of which is hereby incorporated by reference in its entirety.

### BACKGROUND OF THE INVENTION

1. Field of the Invention

The present invention generally relates to contest and games, and more particularly, to a method and apparatus for content promotion via a network.

2. State of the Art

Various types of random drawing type contests are known. Typically, a contestant enters the contest by selecting a subset of indicia from a collection of indicia. The indicia usually takes the form of numerals. Once the contest is complete, a random drawing is performed and the contestant with the matching subset wins.

Advertising uses the concept of contests to promote various products but has had difficulty in targeting specific demographical sections of the population and in managing distribution of content over the Internet. An industry considerably effected by the nature of target advertising is the entertainment industry. As such, attempts have been made to promote to certain audiences however the promotions have lacked the ability to combine Internet technology with content management. Specifically, the music and television/movie industry has had difficulty in managing the distribution of content over the Internet. Various methods have been used to prevent unauthorized use of copyrighted material. By creating a standardized form of encryption to identify legally licensed content, search engines throughout the Internet narrow their search to quickly include only legally licensed content that contains such encryption identifiers. A disadvantage is that the benefits of future marketing of music and television/movie content may be lost.

Therefore, it is desirable to provide a method and apparatus to efficiently increase the buy rates of entertainment content through marketing promotions that may target specific audiences and protect copyrighted material.

### SUMMARY OF THE INVENTION

Accordingly, exemplary embodiments are directed to providing in a computing environment including a network, a web page accessible via said network, and a contest server including a storage medium having an object file, a method for content promotion including accessing from a user client the web page stored in association with the contest server via the network, wherein the web page includes an indicia corresponding with the object file, obtaining a contestant identification, wherein the contestant identification corresponds to the user client, selecting the indicia to provide an opportunity to purchase a content of the content promotion, engaging the object file corresponding to the indicia, and sending to the contest server the contestant identification with an acknowledgment of the selected indicia to enter the user client into a contest.

Another aspect of the present invention provides in a computing environment including a network, a web page accessible via the network, and a contest server including a storage medium having an object file, a data packet capable of being transmitted via the network. The data packet includes a contest game to provide content promotion, wherein a user client enters the contest via the web page, an award system, wherein the user client earns rewards by engaging the data packet, and a coupon dispenser to provide a coupon corresponding with content promotion and a user client location.

In yet another feature, a computer readable medium is provided containing programming which when executed performs the following procedures including: accessing from a user client the web page stored in association with the contest server via the network, wherein the web page includes an indicia corresponding with respective the object file, obtaining a contestant identification, wherein the contestant identification corresponds to the user client, selecting the indicia to provide an opportunity to purchase a content of the content promotion, engaging the object file corresponding to the indicia, and sending to the contest server the contestant identification with an acknowledgment of the selected indicia to enter the user client into a contest.

For a better understanding of the present invention, together with other and further objects thereof, reference is made to the following description, taken in conjunction with the accompanying drawings, and its scope will be defined in the appending claims.

### BRIEF DESCRIPTION OF THE DRAWINGS

The foregoing and other objects and features of the present invention will become more apparent from the following detailed description of preferred embodiments when read in conjunction with the accompanying drawings, wherein:

FIG. 1 illustrates a block diagram useful in describing a system for content promotion in a computing environment;

FIGS. 2-5 illustrates flowcharts useful in describing embodiments of a method for content promotion;

FIG. 6 illustrates an exemplary layout of a data packet used for content promotion; and

FIG. 7 illustrates an exemplary layout of a contest used for content promotion.

### DETAILED DESCRIPTION OF THE INVENTION

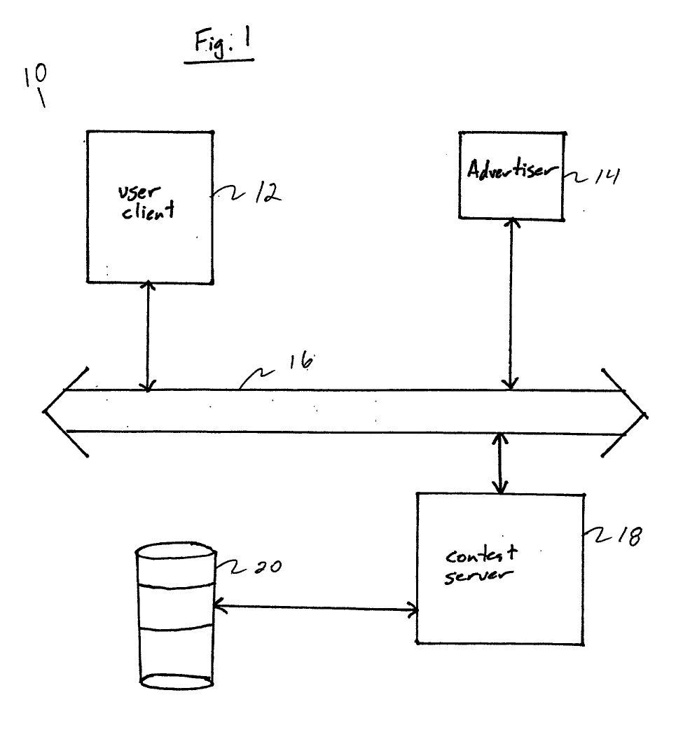

In accordance with the presently claimed invention, FIG. 1 illustrates a block diagram useful in describing a system for content promotion in a computing environment and is generally represented by the numeral 10. System 10 includes a user client 12, an advertiser 14, a network 16, a contest server 18 and a storage medium 20. By way of example and not by limitation, the user client 12 may be a personal computing device such as a computer, a cell phone, a hand held palm pilot type apparatus or a processing unit. The advertiser 14 includes certain content to promote. Such content may be stored as object files on the storage medium 20. Examples of such storage medium 20 include local disk space, network storage and links to other storage devices, as is conventionally known. The advertiser 14 may have access to user client 12 information stored on the storage medium 20 as a result of entering into the content promotion. The network 16 may be a local area network or an Internet world wide web, for example.

The contest server 18 manages content promotion by providing a contest to the user client 12 via indicia connected to the object files. By way of example and not limitation, the object file may be an audio or video file tied to the indicia. In an aspect of the present invention, the indicia may be numbers from a lotto style board, where each number corresponds to a specific movie/music/video clip title.

The advertiser 14 is provided with the opportunity to advertise products to consumers, particularly targeted customers based upon user client 12 information. One or more user clients 12 may participate in the contest promoting specific content. As the user client 12 enters the contest, the opportunity to engage in certain promotions is provided. The promotions may appear as pop up windows which may change intermittently or as part of the contest page. Periodically, promotions may be sent to the user client 12 using the user client 12 information stored on the storage medium 20 or at another location.

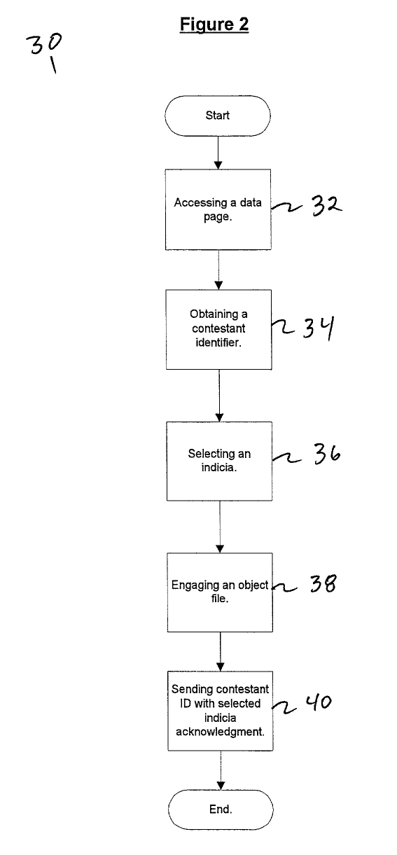

Now referring to FIG. 2 which illustrates a flowchart useful in describing an embodiment of a method for content promotion and generally designated by the numeral 30. First the user client 12 accesses a data page, such as a web page, stored in association with the contest server 18 via the network 16, as indicated at 32. As is conventionally known, a copy of the contest page, upon the user client 12 addressing such page through a universal resource locator (“URL”) for example, is transmitted to the user client 12 via the contest server 18.

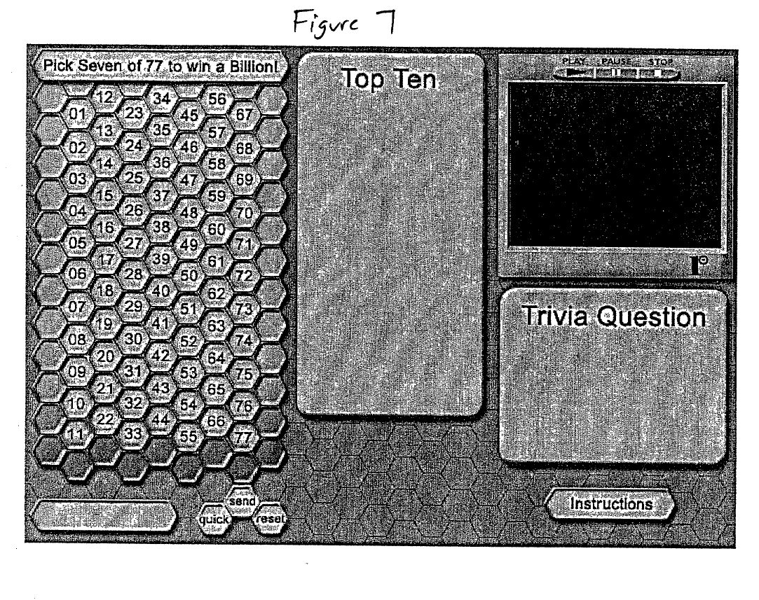

An embodiment of the present invention includes the step of transmitting to a future user client 12 the contents of the data page via information collected by the contest server 18. Promotional items such as coupons may also be transmitted to the user client 12 in relation to specific content promotion. The data page contains information regarding the contest such as a list of indicia and a contest entry form, an example of such is illustrated with FIG. 7. Next contestant identification information relating to the user client 12 is obtained, as indicated at 34.

A feature of the present invention obtains the contestant information by the user client 12 entering information relating to the user client 12 into a data packet. Such information may include name, age, birth date, address, zip code and demographic information. The information is associated to the user client 12 and stored at a location accessible to the contest server 18. By way of example and not limitation, a cookie or Internet type footprint may be used for association of a particular user.

Another aspect obtains the contestant information by the contest server 18 retrieving contestant information via the storage medium 20. Such information may be of the form of a cookie or Internet type footprint or indexed via other corresponding user client 12 information.

Then the user client 12 selects an indicia, as indicated at 36. The indicia may be, for example, numerals, letters or figures. In an embodiment, the user client 12 selects 6 numbers out of a total of 49 numbers in the lotto game style. Another embodiment has 7 numbers out of a total of 77. The selection of an indicia provides the user client 12 with an opportunity to purchase the content of the content promotion being associated with the object file. Once the indicia has been selected, the method then engages the object file associated with the selected indicia, as indicated at 38. By way of example and not limitation, the engagement of the object file may be playing an audio or video file. Each indicia selected may result in the streaming of an audio/video clip that correspond to the content promotion. Next the contestant identification information and the selected indicia are sent to the contest server 18 where the data may be stored at the storage medium 20, as indicated at 40.

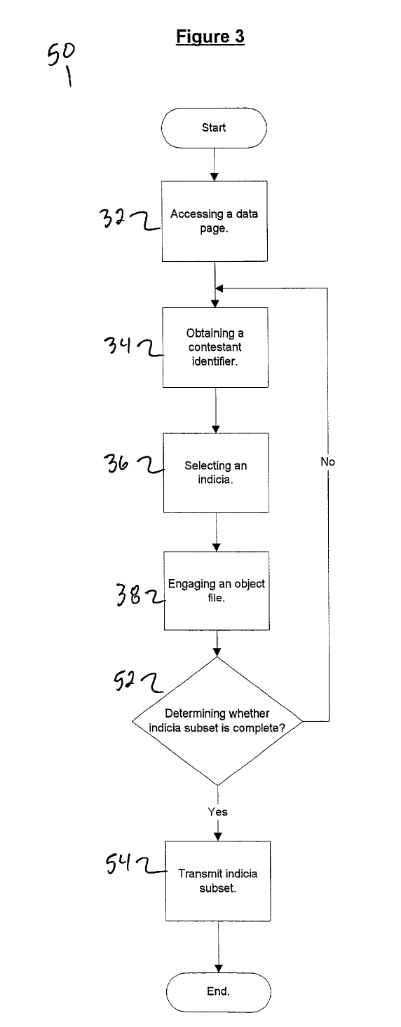

FIG. 3 illustrates a flowchart useful in describing an embodiment of a method for content promotion and generally designated by the numeral 50. First, as described in detail above, steps 32 through 38 are taken. Next the user client 12 enters the selected indicia into an indicia subset and it is determined whether the subset is complete, as indicated at 52. Once the indicia subset is complete, such as by way of example and not limitation all of the 6 numbers out of the 49 total have been chosen, the subset is transmitted to the contest server 18, as indicated at 54.

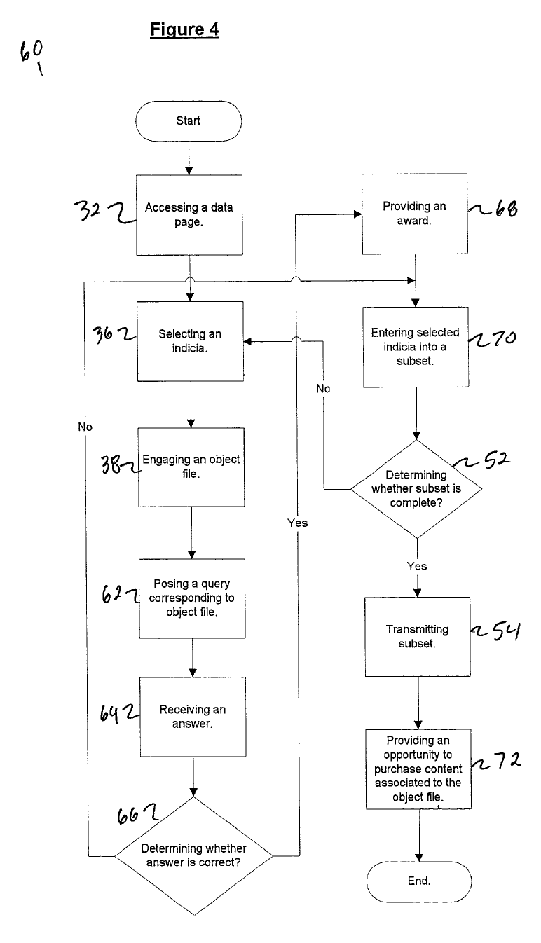

FIG. 4 illustrates a flowchart useful in describing an embodiment of a method for content promotion and generally designated by the numeral 60. First, as described in detail above, steps 32, 36 and 38 are taken. Then a query corresponding to the object file is posed to the user client 12, as indicated at 62. For example, the query may be a trivia question relating to the content promotion associated with the object file. Next the contest server 18 receives an answer to the query from the user client 12, as indicated at 64. Then it is determined whether the answer is correct, as indicated at 66. Upon answering the query correct, the user client 12 earns an award, as indicated at 68. Such award may be points towards the contest or earnings based upon questions answered correctly.

Next the selected indicia is entered into the indicia subset, as indicated at 70. It is then determined whether the subset is complete, as indicated at 52. If the subset is not yet complete, the user client continues by selecting another indicia, as indicated at 36. Upon completion of the subset, the subset of indicia is transmitted to the contest server 18 and entered in as the user client 12 contest entry. Finally, the user client 12 is provided with an opportunity to purchase the content associated with the object files corresponding to the contest entry, as indicated at 72. In an aspect of the present invention, after the user client 12 has entered the subset of indicia, the game company then reveals the subset of official winning numbers. If the user client 12 has matched the selected subset with the winning subset, the user client 12 wins a prize. Another feature includes prizes or points awarded for answering the questions correctly as well as matching the entire subsets.

One embodiment includes that after the streaming of the audio/video clip, the user client 12 may buy the full-length version of the song or movie on CD or DVD or via on-line download connected to an authorized service sanctioned by the copyright owner.

Another aspect of the present invention is for those who just want to enter the contest with no trivia game attached. The user client 12 selects an indicia, such as in the pick 6 of 49 or pick 7 of 77 game, and the corresponding audio/video clip streams. The user client 12 then selects the indicia to provide for one of their official number entries. It may be a simple enter-sweepstakes version that still enables the user client 12 to buy the full-length version of the song or movie on CD or DVD or via on-line download connected to an authorized service sanctioned by the copyright owner.

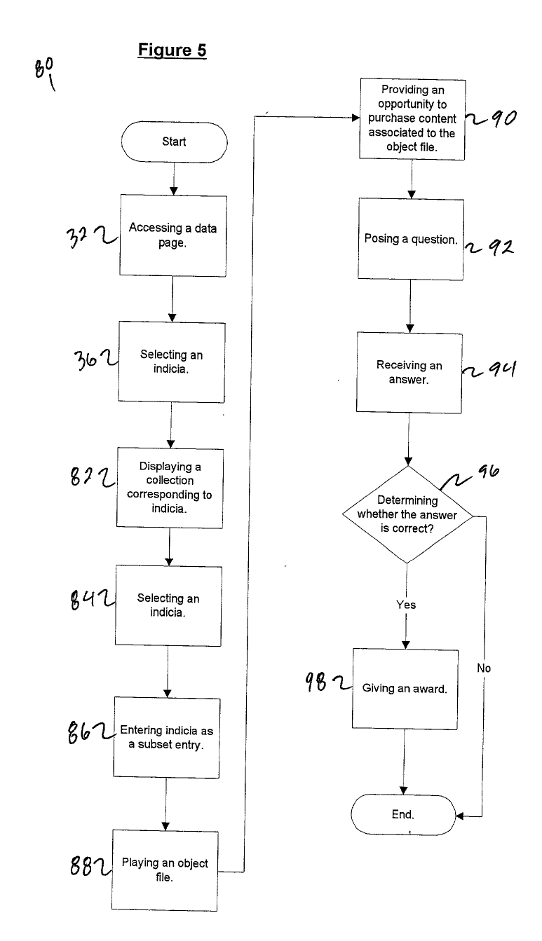

Now referring to FIG. 5 which illustrates a flowchart useful in describing an embodiment of a method for content promotion and generally designated by the numeral 80. First, as described in detail above, steps 32 and 36 are taken. Next a collection corresponding to the selected indicia is displayed, as indicated at 82. By way of example and not limitation, the collection may be a compilation of content, such as Top Ten Lists of songs, movies, TV shows, games, etc. which may motivate the user client 12 to click to sample that song or movie clip—and then give them the opportunity to click to buy it.

Then an indicia from the collection is selected by the user client 12, as indicated at 84. Such selected indicia is then entered into the indicia subset as an entry, as indicated at 86. The object file corresponding with the selected indicia is then played, as indicated at 88. Next the user client is provided with the opportunity to purchase the content represented by the object file, as indicated at 90. Then a question corresponding to the object file is posed to the user client 12, as indicated at 92. For example, the question may be a trivia question relating to the content promotion associated with the object file. Next the contest server 18 receives an answer from the user client 12, as indicated at 94. Then it is determined whether the answer is correct, as indicated at 96. Upon answering the question correct, the user client 12 earns an award, as indicated at 98.

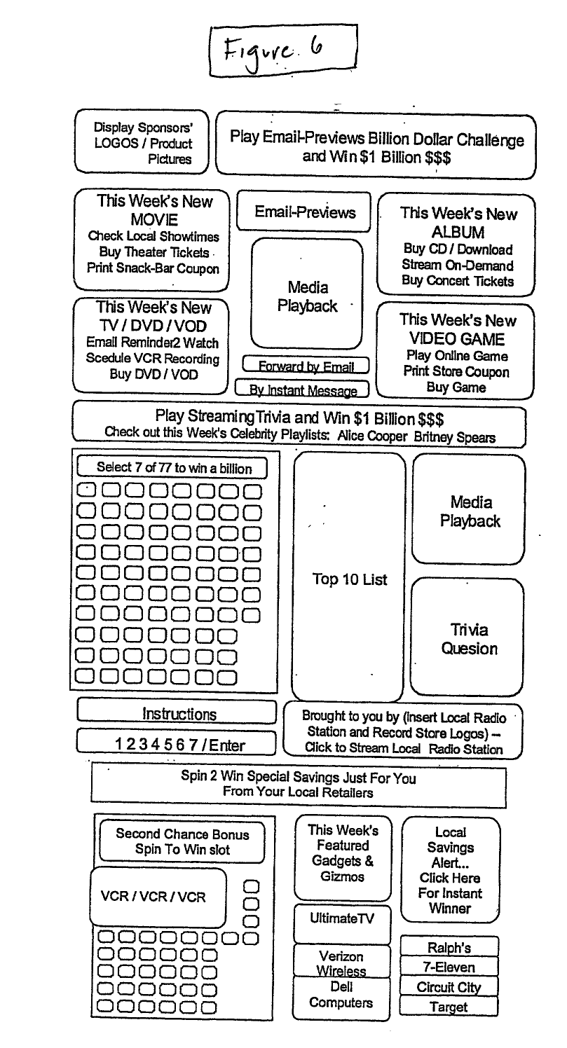

Those skilled in the art will appreciate that the embodiments and processes described above are by way of example only. For example, additional features can be used with the devices illustrated in FIGS. 1, 6 and 7 and/or additional steps can be added to the processes discussed with FIGS. 2-5.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. In a computing environment including a network, a web page accessible via said network, and a contest server including a storage medium having an object file, a method for content promotion comprising the steps of:
accessing from a user client said web page stored in association with the contest server via said network, wherein said web page includes an indicia corresponding with said object file;
obtaining a contestant identification, wherein the contestant identification corresponds to said user client;
selecting said indicia to provide an opportunity to purchase a content of the content promotion;
engaging said object file corresponding to said indicia; and
sending to said contest server said contestant identification with an acknowledgment of said selected indicia to enter the user client into a contest.

2. The method according to claim 1, wherein said obtaining includes the steps of:
entering an information data packet wherein said packet includes information particular to said user client;
associating said user client to said client identification; and
storing said client identification at a location accessible to the contest server.

3. The method according to claim 1, wherein said obtaining includes the step of retrieving said client identification via the contest server.

4. The method according to claim 1, wherein said engaging includes the step of playing an audio file.

5. The method according to claim 1, wherein said engaging includes the step of playing a video file.

6. The method according to claim 1, wherein said method further comprises the steps of:
entering the selected indicia into an indicia subset;
determining whether said indicia subset is complete; and
upon completion of said indicia subset, transmitting said indicia subset.

7. The method according to claim 6, wherein said transmitting includes the steps of:
receiving said indicia subset from the user client via said network;
comparing said indicia subset with a winning subset to provide a win determination or a lose determination; and
upon a win determination, transmitting the user client a winning notification.

8. The method according to claim 1, wherein said method further includes the steps of:
posing a query to the user client, wherein said query corresponds to said object file;
receiving an answer, wherein said answer includes selectively one of a correct answer and an incorrect answer;
upon receipt of said correct answer, providing an award to the user client;
entering said selected indicia into an indicia subset;
determining whether an indicia subset is complete; and
upon completion of said indicia subset, transmitting said indicia subset.

9. The method according to claim 8, wherein said providing includes storing the award in a particular location corresponding to the user client.

10. The method according to claim 8, wherein said transmitting includes the steps of:
receiving said indicia subset from the user client via said network;
comparing said indicia subset with a winning subset to provide a win determination or a lose determination; and
upon a win determination, transmitting the user client a winning notification.

11. The method according to claim 1, wherein said method further includes the step of conducting a contest to provide for content promotion.

12. The method according to claim 11, wherein said conducting comprises the steps of:
selecting a first indicia;
displaying a collection of indicia, wherein said collection corresponds to said first indicia;
selecting a second indicia, wherein said second indicia is located within said collection;
entering said second indicia as a subset entry;
playing said object file to provide promotion of a content, wherein said object file relates to said second indicia; and
providing the user client with an opportunity to purchase said content.

13. The method according to claim 12, said method further comprising the steps of:
posing a query to the user client, wherein said query corresponds to said object file;
receiving an answer, wherein said answer includes selectively one of a correct answer and an incorrect answer; and
upon receipt of said correct answer, providing an award to the user client.

14. The method according to claim 12, wherein said playing occurs simultaneously with the step of posing a query to the user client, wherein said query corresponds to said object file.

15. The method according to claim 12, wherein said method further comprises the steps of:
entering said selected indicia into an indicia subset;
determining whether an indicia subset is complete; and
upon completion of said indicia subset, transmitting said indicia subset.

16. The method according to claim 15, wherein said transmitting includes the steps of:
receiving said indicia subset from the user client via said network;
comparing said indicia subset with a winning subset to provide a win determination or a lose determination; and
upon a win determination, transmitting the user client a winning notification.

17. In a computing environment including a network, a web page accessible via said network, and a contest server including a storage medium having an object file, a data packet capable of being transmitted via said network, said data packet comprising:
a contest game to provide content promotion, wherein a user client enters said contest via said web page;
an award system, wherein the user client earns rewards by engaging said data packet; and
a coupon dispenser to provide a coupon corresponding with content promotion and a user client location.

18. The data packet according to claim 17, wherein said contest provides an opportunity to win points.

19. The data packet according to claim 17, wherein said contest provides an opportunity to win a monetary award.

20. The data packet according to claim 17, wherein said award system is based upon interacting with said data packet by selectively participating in said contest game and engaging an object file and obtaining a coupon.

21. A computer readable medium containing programming which when executed performs the following procedures comprising:
accessing from a user client said web page stored in association with the contest server via said network, wherein said web page includes an indicia corresponding with respective said object file;
obtaining a contestant identification, wherein the contestant identification corresponds to said user client;
selecting said indicia to provide an opportunity to purchase a content of the content promotion;
engaging said object file corresponding to said indicia; and
sending to said contest server said contestant identification with an acknowledgment of said selected indicia to enter the user client into a contest.

22. The medium according to claim 21, wherein said obtaining procedure comprises the procedures of:
entering an information data packet wherein said packet includes information particular to said user client;
associating said user client to said client identification; and
storing said client identification at a location accessible to the contest server.

23. The medium according to claim 21, wherein said obtaining procedure comprises retrieving said client identification via the contest server.

24. The medium according to claim 21, wherein said engaging procedure includes playing an audio file.

25. The medium according to claim 21, wherein said engaging procedure includes the step of playing a video file.

26. The medium according to claim 21, wherein said medium further includes the procedures of:
entering the selected indicia into an indicia subset;
determining whether said indicia subset is complete; and
upon completion of said indicia subset, transmitting said indicia subset.

27. The medium according to claim 26, wherein said transmitting procedure includes the procedures of:
receiving said indicia subset from the user client via said network;
comparing said indicia subset with a winning subset to provide a win determination or a lose determination; and
upon a win determination, transmitting the user client a winning notification.

28. The medium according to claim 21, wherein said medium further includes the procedures of:
posing a query to the user client, wherein said query corresponds to said object file;
receiving an answer, wherein said answer includes selectively one of a correct answer and an incorrect answer;
upon receipt of said correct answer, providing an award to the user client;
entering said selected indicia into an indicia subset;
determining whether an indicia subset is complete; and
upon completion of said indicia subset, transmitting said indicia subset.

29. The medium according to claim 28, wherein said providing procedure includes storing the award in a particular location corresponding to the user client.

30. The medium according to claim 28, wherein said transmitting procedure includes the procedures of:
receiving said indicia subset from the user client via said network;
comparing said indicia subset with a winning subset to provide a win determination or a lose determination; and
upon a win determination, transmitting the user client a winning notification.

31. The medium according to claim 21, wherein said medium further includes the procedure of conducting a contest to provide for content promotion.

32. The medium according to claim 31, wherein said conducting comprises the procedures of:
selecting a first indicia;
displaying a collection of indicia, wherein said collection corresponds to said first indicia;
selecting a second indicia, wherein said second indicia is located within said collection;
entering said second indicia as a subset entry;
playing said object file to provide promotion of a content, wherein said object file relates to said second indicia; and
providing the user client with an opportunity to purchase said content.

33. The medium according to claim 32, said medium further comprises the procedures of:
posing a query to the user client, wherein said query corresponds to said object file;
receiving an answer, wherein said answer includes selectively one of a correct answer and an incorrect answer; and
upon receipt of said correct answer, providing an award to the user client.

34. The medium according to claim 32, wherein said playing procedure occurs simultaneously with the procedure of posing a query to the user client, wherein said query corresponds to said object file.

35. The medium according to claim 32, wherein said medium further comprises the procedures of:
entering said selected indicia into an indicia subset;
determining whether an indicia subset is complete; and
upon completion of said indicia subset, transmitting said indicia subset.

36. The medium according to claim 35, wherein said transmitting procedure includes the procedures of:
receiving said indicia subset from the user client via said network;
comparing said indicia subset with a winning subset to provide a win determination or a lose determination; and
upon a win determination, transmitting the user client a winning notification.
